(19) United States
(12) Patent Application Publication
(10) Pub. No.: US 2012/0254187 A1
(43) Pub. Date: Oct. 4, 2012

(54) METHOD OF CATEGORIZING AN INVENTION WITHIN AN INVENTION LANDSCAPE

(76) Inventors: N. Edward White, Austin, TX (US); G. Edward Powell, JR., Nashville, TN (US)

(21) Appl. No.: 13/171,328

(22) Filed: Jun. 28, 2011

Related U.S. Application Data
(63) Continuation-in-part of application No. 13/079,707, filed on Apr. 4, 2011.

(51) Int. Cl. G06F 17/30

(52) U.S. Cl. 707/740; 707/E17.089

(57) ABSTRACT

A computer-based method is described for categorizing inventions within the context of an invention landscape. A set of key phases and/or semantic properties is employed based upon the likelihood that the description of the invention to be categorized will share these key phrases and/or semantic properties with the descriptions of similar inventions from within the invention landscape. The results are ranked in such a way as to enable a tentative assignment of the target invention to one or more categories, and to optionally estimate the value of the invention.

### RELATED APPLICATION

This application is a continuation-in-part of U.S. patent application Ser. No. 13/079,707, which is hereby incorporated by reference in its entirety.

### BACKGROUND OF THE INVENTION

1. Field of the Invention

The present invention relates to the field of intellectual property asset classification and, in particular, to methods of computer-assisted categorization of patentable inventions within a invention landscape.

2. Description of the Related Art

Intellectual property represents an increasingly significant portion of the wealth and assets of the global community. Patents are an important component of intellectual property, and thus the ability to quickly categorize an invention, thus facilitating the determination of both its patentability and potential value, has increasing utility.

There are at least three common approaches to invention categorization. A content-based approach examines the descriptive text of existing inventions, such as that contained within existing patents or patent applications, and using various techniques, compares that collective content with a description of the invention to be categorized. A citation-based approach examines the citations that are most often part of the description of an invention as contained within a patent application, and using various techniques, uses the categorizations of the patents cited to categorize the citing invention. A metadata-based approach examines the metadata, such as inventor and assignee names, that is part of a patent application associated with an invention, and using various techniques, correlates similar metadata to derive categorization.

The present invention comprises novel extensions to both the content-based and metadata-based approaches. By combining all available descriptors of a given invention, including both traditional text description and metadata, and then searching these descriptors using a set of key phrases and combining the result in a novel way, the present invention produces a useful ranking of likely alternatives for invention categorization.

### BRIEF SUMMARY OF THE INVENTION

The present invention comprises a computer-based method for categorizing inventions within the context of an invention landscape. The term “invention landscape” refers to a collection of inventions which have been categorized previously, using a common categorization scheme. For instance, the set of USPTO granted patents provides such a landscape, because it categorizes each of its patents using the U.S. Patent Classification System. Within an invention landscape, a set of one or more key phrases that are likely to be found within the descriptors of inventions similar to the invention to be categorized is employed. The term “descriptors” refers to all available text or other computer-readable symbols (for example chemical formulas and DNA sequences) associated with an invention, including, but not limited to, specifications, sets of claims, abstracts, associated metadata such as filing dates, classifications, citations, and lists of inventors, as well as arbitrary metadata supplied by end-users or third-parties.

The aforementioned set of key phrases are used to perform individual searches of the invention landscape, the results of which are then processed to extract lists of categories associated with each key phrase. Note that the term “key phrase” is used herein to refer to one or more search terms, which may or may not be logically combined, thus forming the basis of a search query. Similarly, the terms “text” and “phrase” comprise all strings of one or more computer-readable symbols, including the symbols representing spaces, tabs, end-of-lines and other whitespace.

The lists of categories associated with key phrases are then combined in such a way as to enable the ranking of the individual categories within the combined list. This ranking can then be used to assign a tentative category to the target invention.

### BRIEF DESCRIPTION OF THE DRAWINGS

FIG. 1 presents a functional overview of a preferred embodiment, illustrating the use of key phrase matching.

FIG. 2 presents a data snippet from a preferred embodiment, illustrating the insertion of a first key phrase associated category list into a combined category list.

FIG. 3 presents a data snippet from a preferred embodiment, illustrating the insertion of a second key phrase associated category list into a combined category list.

FIG. 4 presents a data snippet from a preferred embodiment, illustrating a combined category list that has been expanded to include category-specific valuation factors.

FIG. 5 presents a functional overview of a preferred embodiment, illustrating the use of semantic similarity.

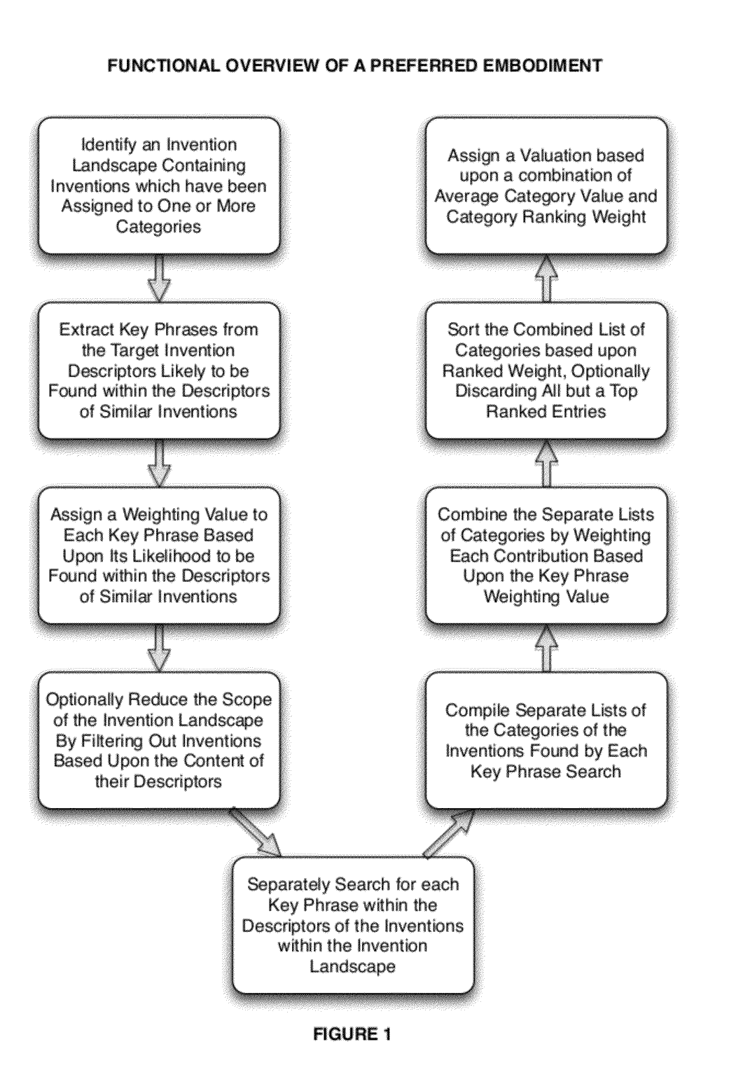

### DETAILED DESCRIPTION OF THE INVENTION

The present invention comprises a computer-based method for categorizing inventions within the context of an invention landscape. An invention landscape, for example the set of all USPTO patents issued since 1970, can comprise millions of inventions. The present invention comprises the use of a computer system with data storage sufficient to hold data representing an entire invention landscape, and a CPU or other device capable of processing said amount of data, either programmed, or in some other way configured, so as to implement one or more of the steps of the invention.

The present invention facilitates the categorization of an invention by utilizing a reference set of inventions, referred to here within as an invention landscape, its members having been previously categorized. In a preferred embodiment, the reference set of inventions is comprised of the set of USPTO granted patents. USPTO patents are categorized using the U.S. Patent Classification System.

Because working with a large reference set of inventions can be both time and resource intensive, an optional preliminary step can be injected, whereby the reference set is reduced in size by pruning its contents using standard dataset filtering techniques. For instance, in a preferred embodiment, a reference dataset of USPTO granted patents is optionally reduced based upon USPTO grant dates. Alternatively, or in conjunction with other filters, simple key phrase searches of the descriptors of the reference inventions are optionally performed, in some cases substantially reducing the size of the reference set.

Within an invention landscape, in order to find similar inventions, a set of one or more key phrases that are likely to be found within the descriptors of similar inventions is employed. For instance, in a preferred embodiment, this key phrase list is generated by parsing the descriptors of the invention to be categorized, using a variety of natural-language parsing techniques well known to those schooled in the art.

With a reference set of inventions as well as an appropriate set of key phrases identified, the next step is to perform a set of searches on the reference set of inventions using each key phrase, or optionally using various combinations of key phrases. The results of each key phrase search is then stored separately. In a preferred embodiment, for example, each key phrase search produces a list of USPTO patents which is then associated with its key phrase, and stored for further processing.

Next, the lists of inventions that were produced from the key phrase searches are combined. For each list of inventions, the individual inventions within the list are examined, and the categories associated with the invention are extracted. Then, the extracted categories associated with each of the inventions within a particular list are combined to produce a combined list of categories. This results in a separate combined list of categories for each key phrase. For example, within a preferred embodiment, the USPTO class/subclass assignments are extracted for each patent contained within each list, and then combined to form a separate list of class/subclasses for each key phrase.

At this point, a list of categories is associated with each key phrase. The key phrases are then assigned to tiers, and each tier assigned a weighting value based upon the likelihood that similar inventions will each contain the tiered key phrases within their descriptors. Optionally, each individual list of categories can now be pruned to include only those items with a weighting value above a certain threshold or within an certain number of top-weighted responses.

Next, the lists of categories associated with each key phrase are combined into a single list, wherein each list item is assigned both a category and a ranking value. Categories are assigned based upon their inclusion in any of the lists of categories associated with each key phrase. The ranking value is derived by summing the key phrase weighting values that appear within the individual key phrase-associated category lists.

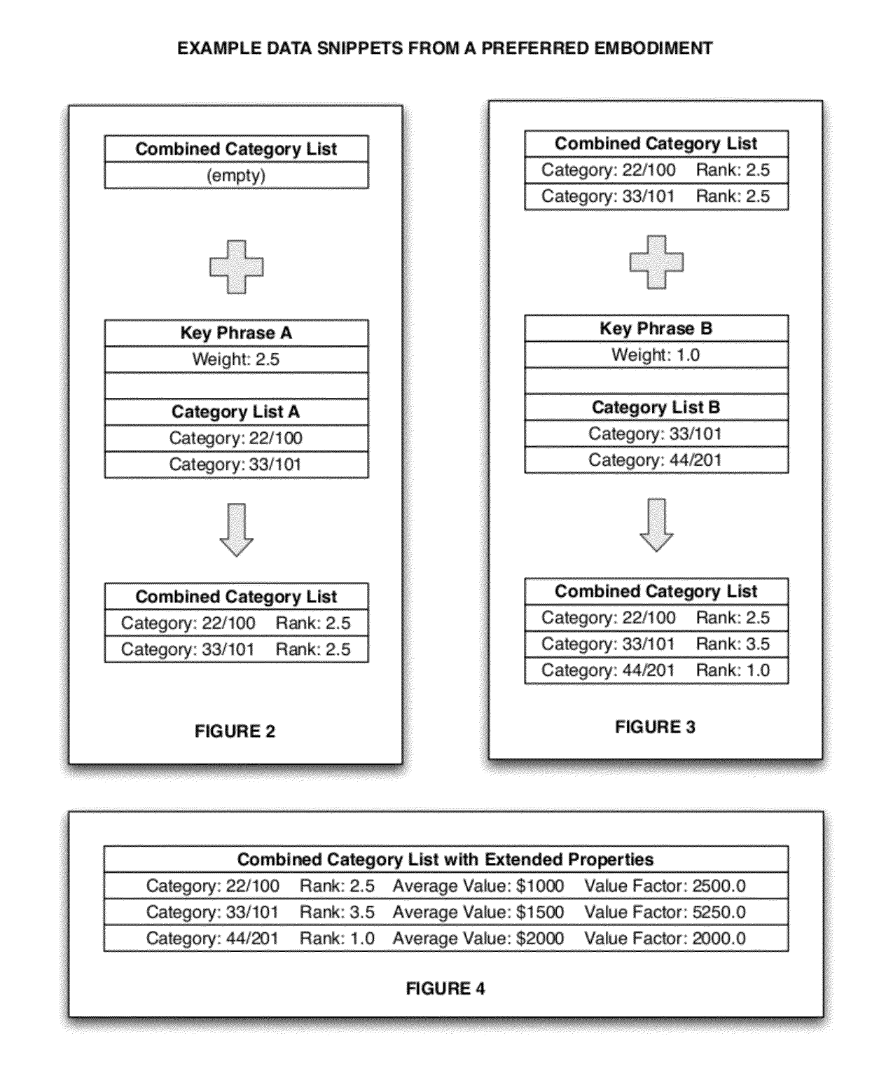

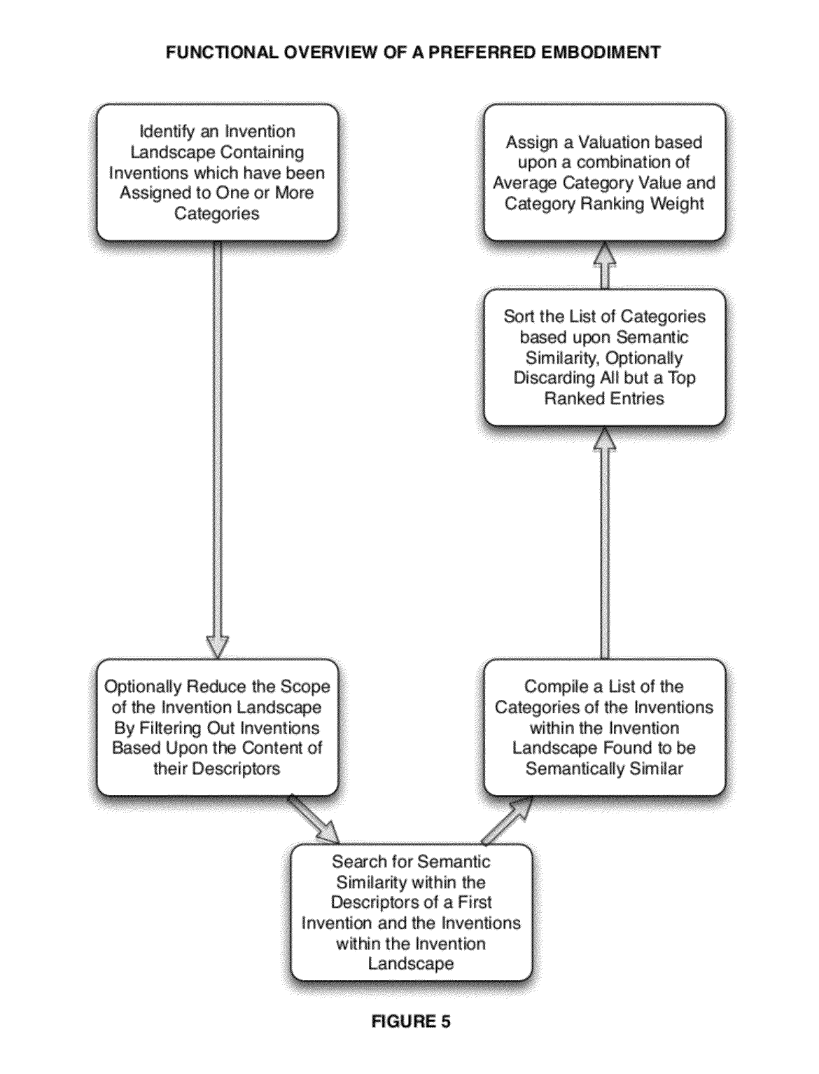

For example, in a preferred embodiment, two key phrases, A and B, might be associated with two category lists, AA and BB, respectively. Category list AA contains USPTO class/subclass pairs 22/100 and 33/101. Category list BB contains USPTO class/subclass pairs 33/101 and 44/201. If the key phrases A and B have been assigned weighting values of 2.5 and 1.0, respectively, then when the two category lists are combined they produce a single combined list as illustrated in FIGS. 2 and 3.

Continuing the example, in a preferred embodiment, category list AA contributes the initial items to the combined list. These initial items are given an initial rank equal to the weighting value of the key phrase associated with category list AA. Because category list BB contains category 33/101, which is already present in the combined list, its associated key phrase weight of 1.0 is added to the existing combined list entry rank value of 2.5, to produce an updated entry, as illustrated in FIG. 3. Category list BB also contains category 44/201, which has not yet been added to the combined list, so that results in a third entry in the combined list.

Next, the combined list of categories is sorted using the ranking values of its individual items, and then optionally pruned to remove all but an arbitrary number of top-ranked items. Alternatively, the list may be pruned by removing those items with a ranking value not above a given threshold. This results in a single sorted list of ranked categories which can then be used for a variety of purposes, including tentative category assignment within the invention landscape.

An alternative method for constructing a list of candidate categories is comprised of the following steps. First, an invention landscape is searched for inventions whose descriptions and/or metadata are semantically similar to the descriptions and/or metadata of the invention to be categorized. Next, the resulting list of semantically similar inventions is optionally pruned so that only the N most semantically similar inventions remain on the list, N being an arbitrary number. Next, the categories associated with each listed invention are extracted and combined to form a single list of candidate categories.

In a preferred embodiment, a first list of candidate categories, derived from semantically similar inventions selected via Latent Semantic Analysis, is used to filter one or more second lists of candidate categories, said one or more second lists having been derived by other means. A variety of filtering techniques are employed, including but not limited to requiring that categories appearing in said one or more second lists also appear in said first list.

In a preferred embodiment, the resulting sorted list of ranked USPTO class/subclasses is used to both assign a tentative class/subclass pair to a new invention, and to predict likely class/subclass assignment by the USPTO. Further, this list is then presented along with additional information associated with each class/subclass, for example class/subclass average market value and value trend information, so that the invention's descriptors can optionally be fine-tuned to better steer the likelihood of its assignment to an appropriate category or set of categories.

In the case where a particular invention landscape contains categories for which average valuation amounts have been either calculated, or in some other way assigned, the sorted list of ranked categories can be used to produce a valuation estimate. The value estimate is produced by taking the category-based average value, V, associated with each item in the combined list of categories, and multiplying by the item's ranking value, R, to produce a valuation factor for each list item, VF:

VF=V*R. (1)

Then, all of the ranking values, R, associated with items in the combined list of categories are summed, and used to divide the sum of the valuation factors, VF, thus producing a weighted average valuation estimate, VE:

VE=ΣVF/ΣR. (2)

For example, in a preferred embodiment, assume that the combined category list comprises the list items as depicted in FIG. 3. Applying category-based average values, and calculating the respective value factors, results in the expanded list items as depicted in FIG. 4. Then again referring to FIG. 4, dividing the sum of the list item value factors (9750) by the sum of the list item ranking values (7.0), produces an value estimate of $1392.85.

Taking valuation a step further, the above-described steps are performed periodically, at regular intervals, providing valuation data sets that are then used to derive valuation trends, using regression analysis or other known trend-detection methodologies.

We claim:

1. A method of categorizing an invention, comprising the steps of:
identifying those inventions within an invention landscape that have been assigned to one or more categories;
semantically matching by computer the invention to be categorized against said those inventions that have been assigned to one or more categories;
choosing one or more semantically matched inventions, based upon degree of semantic similarity with said invention to be categorized; and
constructing a first list of categories from said chosen inventions, by examining each chosen invention and identifying those categories to which said each chosen invention has been assigned, and appending to said first list of categories those said identified categories which have yet to be appended.

2. The method of claim 1, further comprising the step of:
filtering a second list of categories, said second list of categories having been constructed by other means, by discarding any categories in said second list of categories that do not appear in said first list of categories.

3. The method of claim 1, wherein said one or more categories comprise the set of USPTO classes.

4. The method of claim 1, wherein said one or more categories comprise the set of USPTO classes and subclasses.

5. The method of any one of claims 1-4, further comprising the steps of:
assigning a valuation amount to each of the said one or more categories;
deriving a valuation amount for the target invention, by averaging the valuation amounts associated with each of the said one or more categories that appears within the said first list of categories.

6. The method of any one of claims 1-4, further comprising the steps of:
assigning a valuation amount to each of the said one or more categories;
multiplying each count of the number of times each category appears, by the valuation amount assigned to the category associated with said count, thereby producing a set of category-specific factors; and
deriving a valuation amount for the target invention, by dividing the sum of the said category-specific factors by the sum of the said count of the number of times each category appears.
